(19) United States
(12) Patent Application Publication
(10) Pub. No.: US 2012/0046172 A1
(43) Pub. Date: Feb. 23, 2012

(54) METHODS FOR USE OF TRIALKYLBENZYLAMMONIUM HALIDE COMPOSITIONS AS NON-SELECTIVE TERRESTRIAL PLANT HERBICIDES

(76) Inventor: James B. Nabors, Jamestown, NC (US)

(21) Appl. No.: 13/212,305

(22) Filed: Aug. 18, 2011

Related U.S. Application Data
(60) Provisional application No. 61/374,799, filed on Aug. 18, 2010.

(51) Int. Cl. A01N 57/20; A01P 13/00; A01N 33/12

(52) U.S. Cl. 504/127; 504/345; 504/148

(57) ABSTRACT

Disclosed are novel methods for controlling higher terrestrial plants using at least one trialkylbenzyl ammonium halide. In one example, the trialkylbenzyl ammonium halide includes the chemical formula below

C₆H₅—CH₂—N(+)R₁R₂R₃X(−)

wherein, R₁ and R₂ are each independently C₁ to C₄ alkyl; R₃ is C₈ to C₁₈ alkyl or alkenyl; X is chloride or bromide. The methods of the present disclosure are useful for controlling both mono- and dicotyledonous plants in a broad range of applications.

This application claims the benefit of Provisional Application Ser. No. 61/374,799 filed Aug. 18, 2010.

### FIELD

The current disclosure relates generally to herbicides, and more specifically to methods of controlling unwanted higher terrestrial plants.

### BACKGROUND

The elimination of weeds and other undesirable plants in agricultural, horticultural and residential settings is an important market with a very significant economic value. There are many products available as solutions for this problem, but applicant desires new solutions that offer additional benefits, for example, methods that provide rapid and effective control of undesirable plants with a composition that is economic and environmentally friendly. The present disclosure provides at least one of these, or additional, benefits.

The active ingredients of the present invention include members of the substituted quaternary ammonium salt family. Trialkylbenzyl quaternary ammonium halide salts are best known for the bactericidal and algaecidal properties of the compounds. There are a host of industrial, household, medical and textile products based on these properties.

Trialkylbenzyl quaternary ammonium salts are also used as additives in crop protection compositions. U.S. Pat. No. 6,369,001, U.S. Pat. No. 6,165,939, U.S. Pat. No. 6,544,930, U.S. Pat. No. 6,455,473, U.S. Pat. No. 6,451,731 and U.S. Pat. No. 6,277,788 specifically disclose use of alkyldimethylbenzyl ammonium chloride (ADBAC) salts as one of a number of effective additives, both for physical stabilization and activity improvement, for glyphosate compositions. However, the herbicidal properties of the quaternary salt additives are not disclosed, and the quantity of the additive is typically only a fraction of the quantity of glyphosate in the composition. U.S. Pat. No. 4,400,196 and U.S. Pat. No. 5,258,358 disclose compositions comprising glufosinate in combination with ADBAC and other surfactant ingredients as well as methods of weed control using these compositions. Compositions with ratios of ADBAC to glufosinate from 0.5:1 up to 3:1 are possibly disclosed, but no reference is made to the herbicidal properties of the ADBAC component.

There are also patents that disclose use of substituted quaternary ammonium salts as plant growth regulators. U.S. Pat. No. 3,884,670 discloses activity of dimethyl cycloalkyl methyl (or cycloalkyl, amino) quaternary salts as plant growth regulators. No herbicidal activity was reported for the compounds of this disclosure at foliar application rates to pea plants of up to 6 Kg/Ha, and following application, increases in green weight were observed along with increased vigor in tillers and foliage. U.S. Pat. No. 3,580,716 discloses use of tetraisopentyl ammonium salts as plant growth regulators for a variety of plants. The turf grasses sprayed with the '716 compounds exhibited good color and robust growth four weeks after application with no indication of herbicidal effects. DD215228 specifically discloses use of compositions of ADBAC as a growth regulator for certain crop plants (common bean and wheat) with the goal to influence plant growth in a way that will facilitate mechanical harvesting of the crops. Compositions with ADBAC concentrations in the range of 0.1 to 1% are demonstrated to cause leaf desiccation and defoliation of bean plants and show beneficial symptoms of plant stunting with wheat plants. There is no indication that the vigor of the crop plants is destroyed by application of these compositions. WO86/07237 discloses plant growth regulating compositions comprising trialkylbenzyl ammonium salts, the range of which would include ADBAC and closely related compounds. These compositions are used for beneficial growth regulation effects on cultivated crop plants of cereals, papilionacae, sunflower, cotton and maize. No damaging effects were observed with these compositions. In fact the following statement is made (page 6, lines 16-20) “No crop reduction or phytotoxic symptoms could be observed on the plants upon spraying with the compositions according to the invention even in case of overdose or when it was not applied in the phenological stage suitable to get optimal effect.”

### SUMMARY

Applicant discovered, to his surprise, that trialkylbenzyl ammonium halides exhibit unexpected herbicidal properties, enabling fast and effective control of a broad range of undesirable terrestrial plants. Accordingly, the current disclosure is directed to various methods for controlling unwanted higher terrestrial plants using trialkylbenzyl ammonium halides.

In one aspect, a method includes controlling higher plants by the application of a herbicidally effective amount of at least one trialkylbenzyl ammonium halide to a higher plant.

In another aspect, the current disclosure is directed to methods of controlling an unwanted higher terrestrial plant comprising applying to the terrestrial plant a herbicidally effective amount of a trialkylbenzyl ammonium halide(s) of the chemical formula

C₆H₅—CH₂—N(÷)R₁R₂R₃X(−)

wherein, R₁ and R₂ are each independently C₁ to C₄ alkyl; R₃ is Cₐ to C₁₋₈ alkyl or alkenyl; and X is chloride or bromide.

In another aspect, the current disclosure is directed to methods of controlling an unwanted higher terrestrial plant comprising applying to the terrestrial plant a composition comprising a herbicidally effective amount of a trialkylbenzyl ammonium halide(s) of the chemical formula

C₆H₅—CH₂—N(+)R₁R₂R₃X(−)

wherein, R₁ and R₂ are each independently C₁ to C₄ alkyl; R₃ is C₈ to C₁₈ alkyl or alkenyl; and X is chloride or bromide, and at least one additional herbicide.

The above summary was intended to summarize certain embodiments of the present disclosure. Methods and compositions will be set forth in more detail, along with examples demonstrating efficacy, in the detailed description below. It will be apparent, however, that the detailed description is not intended to limit the present invention, the scope of which should be properly determined by the appended claims.

### DESCRIPTION OF EXEMPLARY EMBODIMENTS

The current disclosure is directed to, inter alia, a variety of methods of controlling higher terrestrial plants. In one embodiment, a method comprises applying a herbicidally effective amount of at least one trialkylbenzyl ammonium halide to a higher plant. Application may be by any of the variety of ways known to those skilled in the art, including spraying, for example.

In another embodiment, the present disclosure is directed to methods of controlling unwanted higher terrestrial plants comprising the application of trialkylbenzylammonium halides of the chemical formula below for non-selective control of terrestrial plants

C₆H₅—CH₂—N(+)R₁R₂R₃X(−)

wherein, R₁ and R₂ are each independently C₁ to C₄ alkyl, R₃ is C₅ to C₁₈ alkyl or alkenyl, X is chloride or bromide. Exemplary members of this family have both R₁ and R₂ as methyl, with R₃ as C₈to C₁₈ alkyl or alkenyl, and X is chloride. Application amounts may vary, but will include the application of herbicidally effective amounts.

One form of trialkylbenzylammonium chloride has both R₁ and R₂ as methyl, R₃ with an alkyl chain C₁₂ to C₁₅, and X as chloride (CAS 68424-85-1). The R₃ alkyl chain length may be varied to include other alkyl chain length ranges such as C₁₂ to C₁₈, C₈ to C₁₈, C₁₂ to C₁₄, as well as mixtures of these variants.

The methods of the present invention are useful for inhibiting the growth of both mono- and dicotyledonous plants in a wide variety of higher plant applications. The higher (vascular) plants include plants in the kingdom Plantae that have specialized tissues for conducting water, minerals, and photosynthetic products through the plant. Higher plants include the ferns, clubmosses, horsetails, flowering plants, conifers and other gymnosperms. In sharp phenotypic and genotypic contrast are the lower (nonvascular) plants, which include both earlier-derived lineages in Plantae (e.g., mosses, hornworts, and liverworts) and members of other kingdoms (the various algae).

Potential uses include, but are not limited to, control of weeds in industrial or railway sites; homeowner uses for eradication of plants in mulched areas or around paths, trees or fences; and use in agricultural fields for burndown of weeds before planting or crop emergence. Exemplary mono- and dicotyledonous plant families include, but are not limited to, Cyperaceae, Poaceae, Pontaderiaceae, Portulacaceae, Chenopodiaceae, Convolvulaceae, Amaranthaceae, Rubiaceae.

Compositions of the present invention include aqueous solutions of the trialkylbenzyl ammonium halide, e.g. any of those described above. Typical compositions will include trialkylbenzyl ammonium halide at a concentration of at least about 1.5%. More typical compositions will have a trialkylbenzyl ammonium halide concentration in the range of 1.5% to 35%. Ranges disclosed herein are considered to include any and all subranges between (and inclusive of) the minimum value of 1.5% and the maximum value of 35%; that is, all subranges beginning with a minimum value of 1.5% or more, e.g. 1.5% to 25%, and ending with a maximum value of 35% or less, e.g., 4.5 to 35%, as well as all ranges beginning and ending within the end points, e.g. 2% to 9%, 3% to 8%, 3% to 9%, 4% to 7%, and finally to each number, e.g. 2%, 3%, 4%, 5%, 6%, 7%, 8%, 9% and 10% etc., including subsets within those ranges, and about 1.6% to about 25%, and 2% to 10%.

Compositions may optionally comprise additional surface active agents, e.g. agents to improve at least one of the dispersing/emulsifying, absorbing, spreading, sticking and/or pest-penetrating properties of composition. Exemplary surface active agents include non-ionic surfactants, crop oil concentrates, nitrogen-surfactant blends, esterified seed oils, organo-silicones, etc.

The trialkylalkylbenzylammonium salt active ingredients are commercially available from a number of suppliers as aqueous solutions in concentrations ranging up to 80%. These concentrates may contain up to about 20% of ethanol as a stabilizer. Examples of commercially available products include the BTC® series from Stepan Company, The Barquat® series from Lonza Group Ltd. or AquaChem® Algaecide concentrates from Chemtura Corporation. The inventive compositions may be prepared by dilution of the aqueous concentrate to the desired concentration with water and stirring vigorously to ensure complete mixing.

Another embodiment of the current disclosure includes methods of use of a herbicidally effective dose of a compound of the present disclosure in combination with one or more other herbicides, and optionally other surface active additives, for non-selective control of terrestrial plants. Glyphosate, especially in the form of its agriculturally active salts, is a preferred mixing partner for the herbicidal compositions disclosed herein. Useful ratios, based on weight percent, of the quaternary salts of the present invention to the glyphosate additive, will range from about 15:1 to about 1:1. In one example, the range will be from about 8:1 to about 3:1. In another example, the range will be from about 8:1 to about 5:1. In compositions comprising glufosinate, the range will be, in one example, from about 15:1 to about 4:1, in another example, from about 8:1 to about 5:1. Some examples will exclude glufosinate. Concentration ranges may be similar for other composition examples having other herbicides. In some examples, concentration determination may be based on acid equivalents.

The following examples illustrate the herbicidal properties and methods of use of the inventive compositions, but should not be considered limitative of the scope of the invention.

### Example I

### Preparation of 2% ADBAC Composition

A quantity (28 grams) of 50% concentrate of alkyldimethylbenzylammonium chloride, with n-alkyl group distribution of 40% C₁₂, 50% C₁₄, 10% C₁₆ (CAS #68424-85-1), was diluted with water (672 grams) while stirring vigorously until completely mixed.

### Example II

A vigorously growing area of spotted spurge (Euphorbia maculata) was sprayed with the composition of Example I until the leaves of the plants were wetted with solution. Temperature at time of application was 90° F., and no rainfall occurred during the first 24 hours of the trial period. Ratings of the desiccation effects were made over time after application on a 1 to 10 scale as follows: 0=no effect, 5=50%, 10=100%. Results are shown in the table below.

| Days | Rating |
|---|---|
| 1 | 1 |
| 2 | 2 |
| 3 | 4 |
| 4 | 5 |
| 5 | 6 |
| 6 | 7 |
| 7 | 7.5 |
| 8 | 8.5 |
| 9 | 8.5 |

### Example III

A small area of vigorously growing tall fescue (Festuca arundinacea) was sprayed with the composition of Example I until the leaves of the grass were wetted with solution. Temperature at time of application was 92° F., and no rainfall occurred during the first 24 hours of the trial period. Ratings of the desiccation effects were made over time after application on a 1 to 10 scale as follows: 0=no effect, 5=50%, 10=100%. Results are shown in the table below.

| Days | Rating |
|---|---|
| 1 | 2.5 |
| 2 | 3.5 |
| 3 | 6 |
| 4 | 8 |
| 5 | — |
| 6 | 9.8 |
| 34 | 9.8 |

### Example IV

A small area of vigorously growing smooth crabgrass (Digitaria ischaemum) was sprayed with the composition of Example I until the leaves of the grass were wetted with solution. Temperature at time of application was 90° F., and no rainfall occurred during the first 24 hours of the trial period. Ratings of the desiccation effects were made over time after application on a 1 to 10 scale as follows: 0=no effect, 5=50%, 10=100%. Results are shown in the table below.

| Days | Rating |
|---|---|
| 1 | 3 |
| 2 | 5 |
| 3 | 7.5 |
| 4 | 7.5 |
| 5 | 7.5 |
| 6 | 7.5 |
| 7 | 7.5 |
| 8 | 7.5 |

### Example V

### Preparation of 2% ADBAC Plus 0.5% Glyposate IPA Salt Composition

A quantity (12 grams) of 50% concentrate of alkyldimethylbenzylammonium chloride with n-alkyl group distribution of 40% C₁₂, 50% C₁₄, 10% C₁₆ (CAS #68424-85-1) was mixed with 156 grams of 0.96% glyphosate IPA salt solution (Ortho® Total Kill Weed & Grass Killer), and this mixture was diluted with 132 grams of water while stirring vigorously until completely mixed.

### Example VI

A small area (one square foot) of vigorously growing smooth crabgrass (Digitaria ischaemum) was sprayed with the composition of Example V until the leaves of the grass were wetted (10 grams of solution). Temperature at time of application was 92° F., and no rainfall occurred during the first 24 hours of the trial period. Ratings of the desiccation effects were made over time after application on a 1 to 10 scale as follows: 0=no effect, 5=50%, 10=100%. Results are shown in the table below.

| Days | Rating |
|---|---|
| 1 | 1 |
| 2 | 1.5 |
| 3 | 4.5 |
| 4 | 6.5 |
| 5 | 8.5 |
| 6 | 9 |
| 7 | 9.5 |
| 8 | 9.9 |
| 22 | 9.9 |

### Example VII

A small area (one square foot) of vigorously growing bermudagrass (Cynodon dactylon) was sprayed with the composition of Example I until the leaves of the grass were wetted (14 grams of solution). Temperature at time of application was 89° F., and no rainfall occurred during the first 24 hours of the trial period. Ratings of the desiccation effects were made over time after application on a 1 to 10 scale as follows: 0=no effect, 5=50%, 10=100%. Results are shown in the table below.

| Days | Rating |
|---|---|
| 1 | 2.5 |
| 2 | 4 |
| 3 | 6 |
| 4 | 8 |
| 5 | 8.5 |
| 6 | 9 |
| 7 | 9 |
| 8 | 9 |

### Example VIII

A small area (one square foot) of vigorously growing bermudagrass (Cynodon dactylon) was sprayed with the composition of Example V until the leaves of the grass were thoroughly wetted (20 grams of solution). Temperature at time of application was 92° F., and about one-half inch of rainfall occurred 2.5 hours after application. Ratings of the desiccation effects were made over time after application on a 1 to 10 scale as follows: 0=no effect, 5=50%, 10=100%. Results are shown in the table below.

| Days | Rating |
|---|---|
| 1 | 4.5 |
| 2 | 5.5 |
| 3 | 7.5 |
| 4 | 9 |
| 5 | 9.8 |
| 6 | 9.8 |
| 7 | 9.8 |
| 8 | 9.8 |
| 22 | 9.8 |

### Example IX

### Preparation of 3% ADBAC Composition

A quantity (18 grams) of 50% concentrate of alkyldimethylbenzylammonium chloride, with n-alkyl group distribution of 40% C₁₂, 50% C₁₄, 10% C₁₆ (CAS #68424-85-1), was diluted with water (282 grams) while stirring vigorously until completely mixed.

### Example X

A single plant of Virginia buttonweed (Diodia virginiana) was sprayed until the plant was thoroughly wetted with the composition of Example IX. The temperature was 91° F., and no rain occurred within the first 24 hours of the test period. Ratings of the desiccation effects were made over time after application on a 1 to 10 scale as follows: 0=no effect, 5=50%, 10=100%. Results are shown in the table below.

| Days | Rating |
|---|---|
| 1 | 4 |
| 2 | 6.5 |
| 3 | 8 |
| 4 | 8.5 |

As demonstrated by the experiments outlined above, compositions and methods of the present disclosure elicit rapid and unexpected herbicidal effects enabling fast and effective control of a range of terrestrial plants.

Numerous characteristics and advantages have been set forth in the foregoing description, together with details of structure and function. The disclosure, however, is illustrative only, and changes may be made in detail, especially in matters of application, concentration, surface active agents, etc. within the principle of the disclosure, to the full extent indicated by the broad general meaning of the terms in which the general claims are expressed.

Notwithstanding that the numerical ranges and parameters setting forth the broad scope of the invention are approximations, the numerical values set forth in the specific examples are reported as precisely as possible. Any numerical value, however, inherently contains certain errors necessarily resulting from the standard deviation found in their respective testing measurements. Moreover, all ranges disclosed herein are to be understood to encompass any and all subranges subsumed therein, and every number between the end points. For example, a stated range of “1 to 10” should be considered to include any and all subranges between (and inclusive of) the minimum value of 1 and the maximum value of 10; that is, all subranges beginning with a minimum value of 1 or more, e.g. 1 to 6.1, and ending with a maximum value of 10 or less, e.g., 5.5 to 10, as well as all ranges beginning and ending within the end points, e.g. 2 to 9, 3 to 8, 3 to 9, 4 to 7, and finally to each number 1, 2, 3, 4, 5, 6, 7, 8, 9 and 10 contained within the range. Additionally, any reference referred to as being “incorporated herein” is to be understood as being incorporated in its entirety.

It is further noted that, as used in this specification, the singular forms “a,” “an,” and “the” include plural referents unless expressly and unequivocally limited to one referent.

What is claimed is:

1. A method of controlling an unwanted higher terrestrial plant, the method comprising:
applying to the terrestrial plant a herbicidally effective amount of at least one trialkylbenzyl ammonium halide of the chemical formula below
C₆H₅—CH₂—N(+)R₁R₂R₃X(−)
wherein, R₁ and R₂ are each independently C₁ to C₄ alkyl; R₃ is C₈ to C₁₈ alkyl or alkenyl; and X is chloride or bromide.

2. The method of claim 1 wherein R₁ and R₂ are methyl; R₃ is C₈ to C₁₈ alkyl or alkenyl; and X is chloride.

3. The method of claim 1 wherein R₁ and R₂ are methyl; R₃ is C₁₂ to C_{H} alkyl or alkenyl; and X is chloride.

4. The method of claim 1, further including adding at least one surface active additive.

5. The method of claim 1, wherein the terrestrial plant includes specialized tissues for conducting water, minerals, and photosynthetic products through the plant.

6. The method of claim 1, wherein the herbicidally effective amount includes at least 1.5% of the at least one trialkylbenzyl ammonium halide.

7. The method of claim 1, wherein the herbicidally effective amount includes at least one amount in the range of 1.5% to 35% of the at least one trialkylbenzyl ammonium halide.

8. A method of controlling an unwanted higher terrestrial plant, the method comprising: applying to the terrestrial plant a composition comprising
a herbicidally effective amount of at least one trialkylbenzyl ammonium halide of the chemical formula below
C₆H₅—CH₂—N(+)R₁R₂R₃X(−)
wherein, R₁ and R₂ are each independently C₁ to C₄ alkyl; R₃ is C₈ to C₁₈ alkyl or alkenyl; and X is chloride or bromide, and
at least one additional herbicide.

9. The method of claim 8, wherein the composition includes at least one additional surface active additive.

10. The method of claim 8 wherein the at least one additional herbicide includes glyphosate, or an agriculturally active salt thereof.

11. The method of claim 10 wherein, the ratio, based on weight percent, of the quaternary salt to glyphosate, or an agriculturally active salt thereof, is between 15:1 and 1:1.

12. The method of claim 11 wherein, the ratio, based on weight percent, of the quaternary salt to glyphosate, or an agriculturally active salt thereof, is between 15:1 and 3:1.

13. The method of claim 8, wherein the terrestrial plant includes specialized tissues for conducting water, minerals, and photosynthetic products through the plant.

14. The method of claim 8, wherein the herbicidally effective amount includes at least 1.5% of the at least one trialkylbenzyl ammonium halide.

15. The method of claim 8, wherein the herbicidally effective amount includes at least one amount in the range of 1.5% to 35% of the at least one trialkylbenzyl ammonium halide.
